(19) United States
(12) Patent Application Publication
(10) Pub. No.: US 2018/0179108 A1
(43) Pub. Date: Jun. 28, 2018

(54) DISPERSION OF (METH)ACRYLATE COPOLYMER CONTAINING A HYDROXYALKYL (METH)ACRYLATE FUNCTIONAL MONOMER UNIT FOR FLEXIBLE CEMENTITIOUS WATERPROOFING MATERIALS

(71) Applicant: BASF SE, Ludwigshafen (DE)

(72) Inventors: Ming Hua YU, Shanghai (CN); Sheng Xian WANG, Shanghai (CN); Hai Hong FANG, Shanghai (CN); Mei Jia ZHENG, Shanghai (CN); Yong CAI, Shanghai (CN)

(73) Assignee: BASF SE, Ludwigshafen (DE)

(21) Appl. No.: 15/322,948

(22) PCT Filed: Jun. 30, 2015
(86) PCT No.: PCT/EP2015/064899

§ 371 Date: Dec. 29, 2016

(30) Foreign Application Priority Data
Jul. 1, 2014 (CN) PCT/CN2014/081388

(51) Int. Cl. C04B 24/26; C04B 28/04; C08L 33/06

(52) U.S. Cl. CPC C04B 24/2641; C04B 2103/0054; C08L 33/066; C04B 28/04

(57) ABSTRACT

A dispersion of (meth)acrylate copolymer containing a hydroxyalkyl (meth)acrylate comonomer unit, which is obtained from polymerization of monomers comprising or consisting of, based on the total monomer weight, (a) from 25 to 45% by weight of at least one monovinyl aromatic monomer and/or methyl methacrylate; (b) from 50 to 70% by weight of at least one C₄₋₈ alkyl (meth)acrylate; (c) from 2 to 7% by weight of at least one hydroxyalkyl (meth)acrylate; (d) from 0 to 1% by weight of at least one α,β-monoethylenically unsaturated C₃₋₆ monocarboxylic or dicarboxylic acid; and (e) from 0 to 0.65% by weight of (meth)acrylamide, N-hydroxyalkyl (meth)acrylamide, 2-acrylamido-2-methylpropane sulfonic acid or a combination thereof. A powder of (meth)acrylate copolymer containing a hydroxyalkyl (meth)acrylate comonomer unit obtained by drying the dispersion. A flexible cementitious waterproofing material including the dispersion or the powder.

### FIELD OF THE INVENTION

The present invention relates to a dispersion of (meth)acrylate copolymer containing a hydroxyalkyl (meth)acrylate functional monomer unit and use thereof for flexible cementitious waterproofing materials.

### BACKGROUND OF THE INVENTION

Flexible polymer modified cementitious waterproofing materials are widely used in apart-ments, basements, underground water tanks, etc. due to their good tensile strength, adhesion, flexibility, impermeability, corrosion resistance, cracking resistance, durability and the like. Polymer dispersions are often used in flexible polymer modified cementitious waterproofing materials as a modifier. In practice, polymer dispersions of acrylate copolymer and ethylene-vinyl acetate copolymer are conventionally used, wherein dispersions of acrylate copolymer containing (meth)acrylamide comonomer are most widely used due to the good workability and properties of the modified cementitious waterproofing materials.

CN 102911580 A discloses a cross-linked acrylic dispersion for waterproofing coatings which has strong cross-linking density, excellent adhesion to cementitious substrates, strong adhesion, coating strength and excellent cement retarding ability. The dispersion can be applied to both one- and two-component waterproofing coatings. The dispersion is prepared from deion-ized water, an initiator, an emulsifier, n-butyl acrylate, styrene, N-hydroxymethyl acrylamide, diacetone acrylamide, adipic dihydrazide, a defoamer and a neutralizer.

CN 101891859 A discloses an elastic styrene-acrylic dispersion for a polymer cement waterproofing coating, which provides improved toughness, strength and waterproofing property of the resulted coating film. The dispersion is prepared from fatty alcohol polyoxyethylene ether sulfate, fatty alcohol polyoxyethylene ether (meth)acrylate, n-butyl acrylate, styrene, AMPS and N-hydroxymethyl acrylamide.

The drawback of such kind of dispersions is the ammonia release to the environment due to the hydrolysis of acrylamino group upon mixing with cement under strong alkali condition which is resulted from cement hydration. Ammonia is an irritant and can cause burns of skin, eyes, mouth and lungs. Complaints on strong irritative ammonia odor from builders on construction site become more and more serious. Governments have established regulations set-ting forth guidelines for the amount of ammonia that is released into the atmosphere. For example, in China, according to building material industry standard—“Limit of harmful substances of building waterproof coatings”—JC 1066-2008, the ammonia released by polymer modifiers should be lower than 500 mg/kg for waterproof coatings.

In order to reduce or eliminate the ammonia release during the construction, polymer dispersions which will release less ammonia upon mixing with cementitious materials are therefore desired. U.S. Pat. No. 6,617,387 B2 describes use of ammonia-free polymer dispersions as additives in mineral building materials based on hydraulic binders. It is said that the dispersions have high shear stability and electrolyte stability, and the hardened building materials based on hydraulic binders have high strength, high flexibility and a neutral odor at the presence of hydraulic binders. However, the flexibility or the strength of the building materials based on hydraulic binders containing such dispersions can't meet the general requirement for flexible cementitious waterproofing coatings.

It would be advantageous to provide a polymer dispersion useful for flexible cementitious waterproofing materials without the ammonia release problem while maintaining comparable merits to those modifiers containing (meth)acrylamide comonomer unit in flexible cementitious waterproofing materials.

### SUMMARY OF THE INVENTION

The present invention relates to following aspects:

1). A dispersion of (meth)acrylate copolymer containing a hydroxyalkyl (meth)acrylate comonomer unit, which is obtained from polymerization of monomers comprising or consisting of, based on the total monomer weight,

(a) from 25 to 45% by weight of at least one monovinyl aromatic monomer and/or methyl methacrylate;
(b) from 50 to 70% by weight of at least one C₄₋₈ alkyl (meth)acrylate;
(c) from 2 to 7% by weight of at least one hydroxyalkyl (meth)acrylate;
(d) from 0 to 1% by weight of at least one α,β-monoethylenically unsaturated C₃₋₆ monocarboxylic or dicarboxylic acid; and
(e) from 0 to 0.65% by weight of (meth)acrylamide, N-hydroxyalkyl (meth)acrylamide, and/or 2-acrylamido-2-methylpropane sulfonic acid.

2). The dispersion according to above 1), which is obtained from polymerization of monomers comprising or consisting of, based on the total weight of all monomers,

(a) from 25 to 40% by weight, preferably 25 to 35% by weight of at least one monovinyl aromatic monomer and/or methyl methacrylate;
(b) from 55 to 70% by weight, preferably 60 to 70% by weight of at least one C₄₋₈ alkyl (meth)acrylate;
(c) from 2 to 6% by weight, preferably 3 to 6% by weight, most preferably 4 to 6% by weight of at least one hydroxyalkyl (meth)acrylate; and
(d) from 0.05 to 1% by weight, preferably 0.1 to 1 by weight of at least one α,β-monoethylenically unsaturated C₃₋₆ monocarboxylic or dicarboxylic acid.

3). The dispersion according to above 1) or 2), wherein the at least one hydroxyalkyl (meth)acrylate is selected from hydroxy-C₂₋₁₀ alkyl acrylates, hydroxy-C₂₋₁₀ alkyl methacrylates, and any combinations thereof.

4). The dispersion according to above 3), wherein the at least one hydroxyalkyl (meth)acrylate is selected from the group consisting of 2-hydroxyethyl acrylate, 2-hydroxypropyl acrylate, 3-hydroxypropyl acrylate, 2-hydroxybutyl acrylate, 4-hydroxybutyl acrylate, 2-hydroxyethyl methacrylate, 2-hydroxypropyl methacrylate, 3-hydroxypropyl methacrylate, 2-hydroxybutyl methacrylate, 4-hydroxybutyl methacrylate and any combinations thereof, preferably 2-hydroxyethyl acrylate, 2-hydroxyethyl methacrylate, 2-hydroxypropyl acrylate, 2-hydroxypropyl methacrylate and any combinations thereof.

5). The dispersion according to any of above 1) to 4), wherein the monovinyl aromatic monomer is selected from the group consisting of styrene, α-methyl styrene, o- or p-vinyl toluene, p-bromo styrene, p-tert-butyl styrene, and o-, m- or p-chlorostyrene.

6). The dispersion according to any of above 1) to 5), which is obtained from a radically initiated polymerization.

7). The dispersion according to any of above 1) to 6), wherein the copolymer has a glass transition temperature Tg in the range of from −2° C. to −16° C.

8). Powder of (meth)acrylate copolymer containing a hydroxyalkyl (meth)acrylate comonomer unit obtained by drying the dispersion according to any of above 1) to 7).

9). Use of the dispersion according to any of above 1) to 7) or of the powder according to above 8) for flexible cementitious waterproofing materials.

10). Use of the dispersion according to any of above 1) to 7) or of the powder according to above 8) for flexible cementitious waterproofing materials as a modifier.

11). The use according to above 9) or 10), wherein the flexible cementitious waterproofing materials comprise a cement component selected from the group consisting of Portland cements, pozzolanic cements, hydraulic limes, fly ash and natural cements.

12). The use according to above 11), wherein the dispersion according to any of above 1) to 7) is used in an amount of 10 to 100% by weight, in terms of the solid content, relative to the weight of the cement component in the flexible cementitious waterproofing materials.

13). The use according to any of above 9) to 12), wherein the flexible cementitious waterproofing materials further comprise an additive selected from the group consisting of inorganic fillers, rheology modifiers, superplasticizers, defoamers, coalescence agents, plasticizers, and any combinations thereof.

14). A kit of parts for flexible cementitious waterproofing materials, which comprise a first part (A) the dispersion according to any of above 1) to 7), and a second part (B) a cement component selected from the group consisting of Portland cements, pozzolanic cements, hydraulic limes, fly ash and natural cements, an inorganic filler component and an optional additive selected from the group consisting of rheology modifiers, superplasticizers, defoamers, coalescence agents, plasticizers, and any combinations thereof.

15). Flexible cementitious waterproofing materials which comprise the powder according to above 8), a cement component selected from the group consisting of Portland cements, pozzolanic cements, hydraulic limes, fly ash and natural cements, an inorganic filler component and an optional additive selected from the group consisting of rheology modifiers, superplasticizers, defoamers, coalescence agents, plasticizers, and any combinations thereof.

### DETAILED DESCRIPTION OF THE INVENTION

The dispersion of (meth)acrylate copolymer containing a hydroxyalkyl (meth)acrylate comonomer unit according to the present invention is obtained from polymerization of monomers comprising or consisting of, based on the total weight of all monomers,

(a) from 25 to 45% by weight of at least one monovinyl aromatic monomer and/or methyl methacrylate;
(b) from 50 to 70% by weight of at least one C₄₋₈ alkyl (meth)acrylate;
(c) from 2 to 7% by weight of at least one hydroxyalkyl (meth)acrylate;
(d) from 0 to 1% by weight of at least one α,β-monoethylenically unsaturated C₃₋₆ monocarboxylic or dicarboxylic acid; and
(e) from 0 to 0.65% by weight of (meth)acrylamide, N-hydroxyalkyl (meth)acrylamide, and/or 2-acrylamido-2-methylpropane sulfonic acid.

The term alkyl used herein is to be understood to mean linear or branched alkyl groups, preferably having 1 to 10 carbon atoms if the carbon atom number is not specified. The term C₄₋₈ alkyl accordingly mean linear or branched alkyl groups having 4 to 8 carbon atoms, for example, n-butyl, sec-butyl, isobutyl, tert-butyl, n-pentyl, isopentyl, tert-pentyl, n-hexyl or 2-ethylhexyl. The term C₁₋₄ alkyl used herein includes methyl, ethyl, n-propyl, isopropyl, n-butyl, sec-butyl, isobutyl and tert-butyl.

The term (meth)acrylate is to be understood to mean either or both acrylic and methacrylic acid ester. Likewise, the term (meth)acrylamide is to be understood to mean either or both acrylamide and methacrylamide.

The monovinyl aromatic monomer herein is to be understood to include styrene, α-methyl styrene or derivatives thereof, in which the phenyl ring is optionally substituted by 1, 2 or 3 groups selected from C₁₋₄ alkyl groups, halogen, such as bromine or chlorine, and C₁₋₄ alkoxy groups, such as methoxy.

Preferably, the at least one monovinyl aromatic monomer is selected from the group consisting of styrene, α-methyl styrene, o- or p-vinyl toluene, p-bromo styrene, p-tert-butyl styrene, o-, m- or p-chloro styrene, and any combinations thereof.

The monomer (a) is preferably used in an amount of 25% to 40%, more preferably 25% to 35%, based on the total weight of all monomers. The at least one monovinyl aromatic monomer and the methyl methacrylate monomer, if both are used, may be in any ratio.

The monomer (b), i.e. the at least one C₄₋₈ alkyl (meth)acrylate monomer is preferably selected from the group consisting of n-butyl acrylate, isobutyl acrylate, sec-butyl acrylate, n-hexyl acrylate, 2-ethylhexyl acrylate, n-butyl methacrylate, isobutyl methacrylate, sec-butyl methacrylate, n-hexyl methacrylate, 2-ethylhexyl methacrylate, and any combinations thereof, with n-butyl acrylate and 2-ethylhexyl methacrylate, especially n-butyl acrylate being especially preferred.

The monomer (b) is preferably used in an amount of 55% to 70%, more preferably 60 to 70%, based on the total weight of all monomers.

As the monomer (c), the at least one hydroxyalkyl (meth)acrylate monomer is preferably hy-droxy-C₂₋₁₀ alkyl, particularly hydroxy-C₂₋₄ alkyl, and especially hydroxy-C₂₋₃ alkyl acrylates and/or methacrylates. The hydroxyalkyl (meth)acrylate is preferably selected from the group consisting of 2-hydroxyethyl acrylate, 2-hydroxypropyl acrylate, 3-hydroxypropyl acrylate, 2-hydroxybutyl acrylate, 4-hydroxybutyl acrylate, 2-hydroxyethyl methacrylate, 2-hydroxypropyl methacrylate, 3-hydroxypropyl methacrylate, 2-hydroxybutyl methacrylate, 4-hydroxybutyl methacrylate, and any combinations thereof. 2-Hydroxyethyl acrylate, 2-hydroxyethyl methacrylate, 2-hydroxypropyl acrylate, 2-hydroxypropyl methacrylate and any combinations thereof are most preferable.

The monomer (c) is preferably used in an amount of 2% to 6%, more preferably 3% to 6%, most preferably 4% to 6%, based on the total weight of all monomers.

The monomer (d), i.e. the at least one α,β-monoethylenically unsaturated C₃₋₆ monocarboxylic or dicarboxylic acid, is preferably selected from the group consisting of acrylic acid, methacrylic acid, ethylacrylic acid, itaconic acid, allylacetic acid, crotonic acid, vinylacetic acid, fumaric acid, maleic acid, 2-methylmaleic acid and any combinations thereof, with acrylic acid, methacrylic acid, itaconic acid and combinations thereof being particularly preferred.

The monomer (d), if present, is preferably used in an amount of 0.05% to 1%, more preferably 0.1% to 1%, based on the total weight of all monomers.

The monomer (e), i.e. the (meth)acrylamide, N-hydroxyalkyl (meth)acrylamide monomer, and/or 2-acrylamido-2-methylpropane sulfonic acid, is preferably absent from the monomers for polymerization.

The N-hydroxyalkyl (meth)acrylamide, if present as monomer (e) alone or combined with (meth)acrylamide, may be N-hydroxy-C₁₋₄ alkyl (meth)acrylamide. Particularly, the N-hydroxyalkyl (meth)acrylamide is selected from the group consisting of N-hydroxymethyl acrylamide, N-2-hydroxyethyl acrylamide, N-2-hydroxypropyl acrylamide, N-3-hydroxypropyl acrylamide, N-2-hydroxybutyl acrylamide, N-4-hydroxybutyl acrylamide, N-hydroxymethyl methacrylamide, N-2-hydroxyethyl methacrylamide, N-2-hydroxypropyl methacrylamide, N-3-hydroxypropyl methacrylamide, N-2-hydroxybutyl methacrylamide, N-4-hydroxybutyl methacrylamide, or any combinations thereof. More particularly, the N-hydroxyalkyl (meth)acrylamide is N-hydroxymethyl acrylamide, N-hydroxymethyl methacrylamide or a combination thereof.

It is to be understood that the total percentage of all monomers is 100% by weight.

According to a preferred embodiment of the present invention, the dispersion of (meth)acrylate copolymer containing a hydroxyalkyl (meth)acrylate comonomer unit is obtained from polymerization of monomers comprising or consisting of, based on the total weight of all monomers,

(a) from 25 to 40% by weight of at least one monovinyl aromatic monomer and/or methyl methacrylate;
(b) from 55 to 70% by weight of at least one C₄₋₈ alkyl (meth)acrylate;
(c) from 2 to 6% by weight of at least one hydroxyalkyl (meth)acrylate; and
(d) from 0.05 to 1% by weight of at least one α,β-monoethylenically unsaturated C₃₋₆ monocarboxylic or dicarboxylic acid.

According to a further preferred embodiment of the present invention, the dispersion of (meth)acrylate copolymer containing a hydroxyalkyl (meth)acrylate comonomer unit is obtained from polymerization of monomers comprising or consisting of, based on the total weight of all monomers,

(a) from 25 to 35% by weight of at least one monovinyl aromatic monomer and/or methyl methacrylate;
(b) from 60 to 70% by weight of at least one C₄₋₈ alkyl (meth)acrylate;
(c) from 3 to 6% by weight, preferably 4 to 6% by weight of at least one hydroxyalkyl (meth)acrylate; and
(d) from 0.1 to 1% by weight of at least one α,β-monoethylenically unsaturated C₃₋₆ monocarboxylic or dicarboxylic acid.

The (meth)acrylate copolymer containing a hydroxyalkyl (meth)acrylate comonomer unit contained in the dispersion obtained by the polymerization may have a glass transition temperature T_{g} in the range of from −2° C. to −16° C.

It is possible that the dispersion of (meth)acrylate copolymer containing a hydroxyalkyl (meth)acrylate comonomer unit is prepared by any radically initiated emulsion polymerization known in the art.

Within the context of the present application, the dispersion of (meth)acrylate copolymer containing a hydroxyalkyl (meth)acrylate comonomer unit is an aqueous dispersion unless otherwise specified.

The radically initiated emulsion polymerization can take place in the presence of an exogenous polymer seed in an amount of 0.04% to 1.5% by weight based on the total weight of all monomers. The exogenous polymer seed is a polymer seed which has been prepared in a separate reaction step or a commercially available polymer seed, whose monomeric composition is different than that of the polymer prepared by the radically initiated emulsion polymerization. The preparation of an exogenous polymer seed is familiar to the skilled person and is typically accomplished by the introduction as initial charge to a reaction vessel of a relatively small amount of monomers and of a relatively large amount of emulsifiers, and by the addition at reaction temperature of a sufficient amount of polymerization initiator. A polystyrene or polymethyl methacrylate polymer seed is particularly preferred. The total amount of exogenous polymer seed is introduced as initial charge to the polymerization vessel before the polymerization reaction is initiated. Total amount of monomers (a) to (e) can be charged to the polymerization vessel continuously in the form of a monomer emulsion under polymerization conditions. Use is made in particular of a polymer seed whose particles have a narrow size distribution and weight-average diameters D_{w} below 100 nm, frequently about 5 nm to about 50 nm, and often about 15 nm to 35 nm.

The radically initiated emulsion polymerization is carried out in the presence of an emulsifier, an initiator and optionally a radical chain transfer agent and other additives which are those conventionally used in the art.

Suitable emulsifiers for preparing the dispersion of (meth)acrylate copolymer according to the present invention include nonionic emulsifiers, anionic emulsifiers, or a combination thereof, preferably anionic emulsifiers. The emulsifier(s) may be used in an amount of 0.1% to 3% by weight based on the total weight of all monomers. The emulsifier(s) may be introduced in the form of a monomer emulsion. It is also possible to introduce a portion of the emulsifier(s) as initial charge to the polymerization vessel before the polymerization reaction is initiated and the remaining amount of the emulsifier(s) is added in the form of a monomer emulsion under polymerization conditions.

Examples of conventional nonionic emulsifiers include ethoxylated mono-, di-, and tri-alkylphenols (EO degree: 3 to 50, alkyl: C₄ to C₁₂) and also ethoxylated fatty alcohols (EO degree: 3 to 80; alkyl: C₈ to C₃₆) wherein EO degree means the degree of ethoxylation. Examples thereof are Lutensol A® grades (C₁₂C₁₄, fatty alcohol ethoxylates, EO degree: 3 to 8), Lutensol AO® grades (C₁₃C₁₅ oxo-process alcohol ethoxylates, EO degree: 3 to 30), Lutensol AT® grades (C₁₆C₁₈, fatty alcohol ethoxylates, EO degree: 11 to 80), Emulan TO® grades (C₁₃ oxo-process alcohol ethoxylates, EO degree: 20 to 40), and Lutensol TO® grades (C₁₃ oxo-process alcohol ethoxylates, EO degree: 3 to 20), all commercially available from BASF SE.

Examples of conventional anionic emulsifiers include alkali metal salts and ammonium salts of alkyl sulfates (alkyl: C₈ to C₁₂), of sulfuric monoesters with ethoxylated alkanols (EO degree: 2 to 30, alkyl: C₁₂ to C₁₈) and with ethoxylated alkylphenols (EO degree: 3 to 50, alkyl: C₄ to C₁₂), of alkylsulfonic acids (alkyl: C₁₂ to C₁₈), and of alkylarylsulfonic acids (alkyl: C₉ to C₁₈).

As a suitable anionic emulsifier, compounds of the general formula (I) may also be mentioned

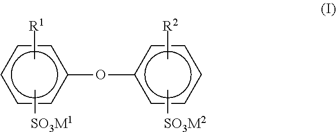

in which R¹ and R² independently are H or C₄₋₂₄ alkyl, preferably linear or branched C₆₋₁₈ alkyl, in particular C₆, C₁₂, or C₁₆ alkyl, and are not simultaneously H, and M¹ and M² can be alkali metal ions and/or ammonium ions, preferably sodium, potassium or ammonium, with sodium being particularly preferred. The compounds (I) are known from U.S. Pat. No. 4,269,749 for example, and are available commercially.

Frequently use is made of technical mixtures which contain a fraction of 50% to 90% by weight of the monoalkylated product, such as Dowfax® 2A1 (commercially available from Dow Chemical Company).

Suitable initiators for preparing the dispersion of (meth)acrylate copolymer according to the present invention are free radical water-soluble substances, in particular water-soluble peroxides or persulfates, for example hydrogen peroxide, potassium, sodium and ammonium persulfates, t-butyl hydroperoxide, peracetic acid and so on. Redox catalysts may also be used which consist of peroxides or persulfates of the above types and reducing agents normally used for this purpose, such as ascorbic acid, sodium bisulfide, sodium sulfoxylate and so on. It is possible for two or more initiators to be used in the emulsion polymerization. In general, the initiator(s) may be used in an amount of 0.1% to 3% by weight based on the total weight of all monomers, preferably 0.1% to 2% by weight. The initiator(s) can be introduced as initial charge to the polymerization vessel before the polymerization is initiated. It is also possible to introduce a portion of the initiator(s) as an initial charge to the polymerization vessel before the polymerization is initiated, and add the remaining amount continuously under polymerization conditions.

In order to reduce the residual monomers, it is common to further add an initiator after the end of the substantial emulsion polymerization, i.e., after a monomer conversion of at least 95%.

In addition to the aforementioned components, a radical chain transfer agent may also be used to control the molecular weight of the copolymer obtained by the polymerization. The amount of the chain transfer agent is generally below 5% by weight based on the total weight of all monomers, preferably below 1% by weight. Particularly, organic thiol compounds are suitable as the chain transfer agent, such as t-dodecyl mercaptan.

The radically initiated emulsion polymerization is carried out at a temperature in the range from 50 to 120° C., preferably 70 to 95° C.

The dispersion of (meth)acrylate copolymer containing a hydroxyalkyl (meth)acrylate comonomer unit according to the present invention can also comprise conventional additives known in the art, such as antimicrobial agent, antifoaming agent, antioxidant and so on. Such additives may be introduced into the dispersion after the completion of the polymerization.

The dispersion of (meth)acrylate copolymer containing a hydroxyalkyl (meth)acrylate comonomer unit according to the present invention has a polymer solid content of from 40 to 60% by weight. It is to be understood that the dispersion may be diluted with water to any desired solid content according to specific applications. The number-average particle diameter (cumulant z-average) of the polymer particles dispersed in the dispersion is generally in the range of 50 to 1000 nm, preferably in the range of 50 to 750 nm, most preferably in the range of 100 to 500 nm.

The weight average molecular weight M_{w} of the copolymer contained in the dispersion according to the present invention ranges from 10,000 to 1,000,000 g/mol, preferably from 50,000 to 500,000 g/mol, most preferably from 100,000 to 300,000 g/mol. The copolymer contained in the dispersion according to the present invention has a M_{w}/Mₙ ratio in the range of 1 to 10, preferably in the range of 1 to 5, most preferably in the range of 2 to 4.

The present invention further relates to use of the dispersion of (meth)acrylate copolymer containing a hydroxyalkyl (meth)acrylate comonomer unit according to the present invention for flexible cementitious waterproofing materials. The composition and preparation of said dispersion are as discussed in detail hereinabove.

The flexible cementitious waterproofing materials comprise a cement component in addition to the dispersion of (meth)acrylate copolymer containing a hydroxyalkyl (meth)acrylate comonomer unit according to the present invention.

There are no specific limitations for the cement contained in the flexible cementitious waterproofing materials. Any known cements such as high alumina cements and silicate cements may be used. The silicate cements herein include, but are not limited to, Portland cements, pozzolanic cements, hydraulic limes, fly ash and natural cements.

The flexible cementitious waterproofing materials also comprise conventional additives known in the art. The additives include, but are not limited to, inorganic fillers such as calcium carbonate, quartz sand, dolomite, fumed silica, kaolin, talc and mica, rheology modifiers such as Walocel® MW 40000, Latekol® D and Starvis® 3003 F, superplasticizers such as Melflux® 2651 F, defoamers such as Lumiten® EL and Foamaster® NXZ, coalescence agents such as Texanol®, plasticizers such as Plastilit® 3060, and so on.

The dispersion of (meth)acrylate copolymer containing a hydroxyalkyl (meth)acrylate comonomer unit according to the present invention is used in an amount of 10% to 100% by weight in terms of the solid content, relative to the weight of cement in the flexible cementitious waterproofing materials.

The dispersion of (meth)acrylate copolymer containing a hydroxyalkyl (meth)acrylate comonomer unit according to the present invention may be mixed with other components such as cements, sand and optional additives which together with said dispersion constitute flexible cementitious waterproofing materials in situ immediately before application thereof. The said dispersion may be homogeneously mixed with the flexible cementitious waterproofing materials via any mixing or blending means.

The present invention also provides a kit of parts for flexible cementitious waterproofing materials, which comprise a first part (A) the dispersion of (meth)acrylate copolymer containing a hydroxyalkyl (meth)acrylate comonomer unit according to the present invention, and a second part (B) a cement component selected from the group consisting of Portland cements, pozzolanic cements, hydraulic limes, fly ash and natural cements, an inorganic filler component, and an optional additive selected from the group consisting of rheology modifiers, superplasticizers, defoamers, coalescence agents, plasticizers, and any combinations thereof.

In a preferred embodiment, the first part (A) and the second part (B) are mixed in situ immediately before application thereof.

In a further preferred embodiment, the first part (A) is used in an amount of 10% to 100% by weight in terms of the solid content, relative to the weight of cement of part (B).

It is to be understood that the dispersion of (meth)acrylate copolymer containing a hydroxyalkyl (meth)acrylate comonomer unit according to the present invention can be con-verted in a simple way, for example, by drying methods such as freeze-drying or spray-drying known in the art, into the corresponding (meth)acrylate copolymer powder.

Accordingly, the present invention further relates to the corresponding (meth)acrylate copolymer powder, use thereof for flexible cementitious waterproofing materials.

Additionally, the present invention provides flexible cementitious waterproofing materials containing the (meth)acrylate copolymer powder obtained from the dispersion of (meth)acrylate copolymer containing a hydroxyalkyl (meth)acrylate comonomer unit according to the present invention.

For the components that may be used in the flexible cementitious waterproofing materials other than the (meth)acrylate copolymer powder, reference may be made to those described hereinabove.

It is to be understood that the (meth)acrylate copolymer powder obtained from the dispersion of (meth)acrylate copolymer containing a hydroxyalkyl (meth)acrylate comonomer unit according to the present invention as described above is used in an amount of 10% to 100% by weight relative to the weight of cement in the flexible cementitious waterproofing materials.

In the context of the present invention, tensile strength, adhesive strength and elongation at break are measured according to GB/T 1677-2008, “Test Method of Building Waterproofing Coatings”, 1st edition, June, 2008. The ammonia release from the dispersion is measured according to JC 1066-2008. The glass transition temperature of copolymers is determined at a heating rate of 10° C./min under nitrogen atmosphere, by differential scanning calorimetry TA Q100 (Waters TA) according to standard ISO 16805:2003, as midpoint temperature. The number-average particle diameter of the dispersion is measured via quasi-elastic light scattering by Malvern Zetasizer Nano ZS-90 according to ISO 13321:1996. The pH of the dispersion is measured by METTLER TOLEDO pH meter according to ISO 967:1996. The polymer solid content of the dispersion is determined by drying the dispersion in oven at 140° C. for 30 minutes according to ISO 3251:2008. The viscosity is determined by Brookfield rotational viscometer RVT at a speed of 20 rpm according to ISO 1652:2011. The molecular weight of the polymer is determined by gel permeation chromatography TOSOH HLC-8120 GPC with tetrahydrofuran as eluent according to ISO 13885-1:1998.

### EXAMPLES

### Example 1

A dispersion is prepared through a process as described below with starting materials shown in Table 1.

The initial charge is added into a reaction vessel with stirring at 120 rpm, and heated to 90° C. When the temperature was reached, 4.6 g of Feed 2 is metered in over 5 minutes. Subsequent-ly, Feed 1 and the remainder of Feed 2 are metered in simultaneously over 3 hours under stirring. The polymerization mixture is then left to post-polymerization at 90° C. for 1 hour. The mixture is cooled to 85° C., and then 33.8 g aqueous t-butyl hydroperoxide solution (10 wt %) and 38 g of sodium bisulfite solution in acetone (13 wt %) are metered in over 2 hours. The resulting mixture is cooled to room temperature. Into the mixture, 32.5 g aqueous sodium hydroxide solution (8 wt %) is added, followed by 0.88 g Tego® Antifoam 2263XP (commercially available from Evonik Degussa Specialty Chemicals (Shanghai) Co., Ltd.), and then 3.9 g fungicide ACTICIDE MV (commercially available from Thor Specialties China Co., Ltd.) is added. The obtained dispersion has a pH of 7.6, a solid content of 56.6% based on the total weight of the dispersion, T_{g} of −9° C., a viscosity of 478 mPa·s, a number-average particle diameter of 203 nm, M_{w} of 167,574 and M_{w}/Mₙ of 2.8.

TABLE 1

| | | |
|---|---|---|
| Initial Charge: | Demineralized water | 344.5 g |
| | Vorproduct T6772 | 9.9 g |
| Feed 1: | Demineralized water | 377.0 g |
| | Lutensol ® AT 18 | 97.5 g |
| | Disponil ® FES 77 | 40.6 g |
| | Styrene | 338 g |
| | Methyl methacrylate | 39 g |
| | n-Butyl acrylate | 780 g |
| | 2-Ethylhexyl acrylate | 65 g |
| | 2-Hydroxyethyl methacrylate | 70.2 g |
| | Acrylic acid | 6.5 g |
| Feed 2: | Aqueous sodium persulfate solution (7 wt %) | 92.9 g |

### Example 2

A dispersion is prepared through a process as described below with starting materials shown in Table 2.

The initial charge is added into a reaction vessel with stirring at 120 rpm, and heated to 95° C. When the temperature was reached, 3.7 g of Feed 2 is metered in over 5 minutes. Subsequent-ly, Feed 1 and the remainder of Feed 2 are metered in simultaneously over 3 hours under stirring. The polymerization mixture is then left to post-polymerization at 95° C. for 1 hour. The mixture is cooled to 90° C., and 33.8 g aqueous t-butyl hydroperoxide solution (10 wt %) and 38 g of sodium bisulfite solution in acetone (13 wt %) are metered in over 2 hours. Then the resulting mixture is cooled to room temperature, and 32.5 g aqueous sodium hydroxide solution (8 wt %) is added. Then, 78 g Emulan TO® 40 solution (20 wt %, commercially available from BASF (China) Co., Ltd.) is added, followed by 0.88 g Tego® Antifoam 2263XP (commercially available from Evonik Degussa Specialty Chemicals (Shanghai) Co., Ltd.). Finally, 3.9 g fungicide ACTICIDE MV (commercially available from Thor Specialties China Co., Ltd.) is added. The obtained dispersion has a pH of 8.1, a solid content of 55.4% based on the total weight of the dispersion, T_{g} of −9° C., a viscosity of 235 mPa·s, a number-average particle diameter of 256 nm, M_{w} of 144,380 and M_{w}/Mₙ of 3.1.

TABLE 2

| | | |
|---|---|---|
| Initial Charge: | Demineralized water | 344.5 g |
| | Vorproduct T6772 | 4.7 g |
| Feed 1: | Demineralized water | 403.0 g |
| | Disponil ® FES 27 | 48.2 g |
| | Styrene | 375.7 g |
| | n-Butyl acrylate | 854.1 g |
| | 2-Hydroxyethyl acrylate | 61.1 g |
| | Acrylic acid | 1.3 g |
| | Methacrylic acid | 5.2 g |
| Feed 2: | Aqueous sodium persulfate solution (7 wt %) | 74.3 g |

### Example 3

A dispersion is prepared through a process as described below with starting materials shown in Table 3.

The initial charge is added into a reaction vessel with stirring at 120 rpm, and heated to 90° C. When the temperature was reached, 5.4 g of Feed 2 is metered in over 5 minutes. Subsequent-ly, Feed 1 and the remainder of Feed 2 are metered in simultaneously over 3.5 hours under stirring. The polymerization mixture is then left to post-polymerization at 90° C. for 1 hour. The mixture is cooled to 85° C., and 39.0 g aqueous t-butyl hydroperoxide solution (10 wt %) and 43.9 g of sodium bisulfite solution in acetone (13 wt %) are metered in over 2 hours. Then the resulting mixture is cooled to room temperature, and 37.5 g aqueous sodium hydroxide solution (8 wt %) is added. Then, 1.02 g Tego® Antifoam 2263XP (commercially available from Evonik Degussa Specialty Chemicals (Shanghai) Co., Ltd.) is added. Finally, 6 g fungicide ACTICIDE MV (commercially available from Thor Specialties China Co., Ltd.) is added. The obtained dispersion has a pH of 6.1, a solid content of 53.5% based on the total weight of the dispersion, T_{g} of −3.8° C., a viscosity of 622 mPa·s, a number-average particle diameter of 258 nm, M_{w} of 152,800 and M_{w}/Mₙ of 3.2.

TABLE 3

| | | |
|---|---|---|
| Initial Charge: | Demineralized water | 397.5 g |
| | Vorproduct T6772 | 12.7 g |
| Feed 1: | Demineralized water | 375.0 g |
| | Disponil ® FES 77 | 46.9 g |
| | Lutensol ® AT 18 | 112.5 g |
| | Styrene | 478.5 g |
| | n-Butyl acrylate | 909.0 g |
| | 2-Ethylhexyl acrylate | 75.0 g |
| | 2-Hydroxyethyl methacrylate | 30.0 g |
| | Acrylic acid | 1.5 g |
| | Methacrylic acid | 6.0 g |
| Feed 2: | Aqueous sodium persulfate solution (7 wt %) | 107.1 g |

### Example 4

A dispersion is prepared through a process as described below with starting materials shown in Table 4.

The initial charge is added into a reaction vessel with stirring at 120 rpm, and heated to 95° C. When the temperature was reached, 4.6 g of Feed 2 is metered in over 5 minutes. Subsequent-ly, Feed 1 and the remainder of Feed 2 are metered in simultaneously over 4.5 hours under stirring. The polymerization mixture is then left to post-polymerization at 95° C. for 1 hour. The mixture is cooled to 90° C., and 29.9 g aqueous t-butyl hydroperoxide solution (10 wt %) and 32.0 g of sodium bisulfite solution in acetone (13 wt %) are metered in over 2 hours. Then the resulting mixture is cooled to room temperature, and 32.5 g aqueous sodium hydroxide solution (8 wt %) is added. Then, 0.88 g Tego® Antifoam 2263XP (commercially available from Evonik Degussa Specialty Chemicals (Shanghai) Co., Ltd.) is added. Finally, 3.9 g fungicide ACTICIDE MV (commercially available from Thor Specialties China Co., Ltd.) is added. The obtained dispersion has a pH of 7.0, a solid content of 56.7% based on the total weight of the dispersion, T_{g} of −2.7° C., a viscosity of 3310 mPa·s, a number-average particle diameter of 183 nm, M_{w} of 137,820 and M_{w}/Mₙ of 3.6.

TABLE 4

| | | |
|---|---|---|
| Initial Charge: | Demineralized water | 351.0 g |
| | Vorproduct T6772 | 15.8 g |
| Feed 1: | Demineralized water | 325.0 g |
| | Disponil ® FES 77 | 81.3 g |
| | Lutensol ® AT 18 | 65.0 g |
| | Styrene | 429.0 g |
| | n-Butyl acrylate | 746.2 g |
| | 2-Ethylhexyl acrylate | 65.0 g |
| | 2-Hydroxypropyl acrylate | 52.0 g |
| | Acrylic acid | 7.8 g |
| Feed 2: | Aqueous sodium persulfate solution (7 wt %) | 92.9 g |

### Example 5

A dispersion is prepared through a process as described below with starting materials shown in Table 5.

The initial charge is added into a reaction vessel with stirring at 120 rpm, and heated to 90° C. When the temperature was reached, 3.7 g of Feed 2 is metered in over 5 minutes. Subsequently, Feed 1 and the remainder of Feed 2 are metered in simultaneously over 3.5 hours under stirring. The polymerization mixture is then left to post-polymerization at 90° C. for 1 hour. The mixture is cooled to 85° C., and 30.4 g aqueous t-butyl hydroperoxide solution (10 wt %) and 41.0 g of sodium bisulfite solution in acetone (13 wt %) are metered in over 2 hours. Then the resulting mixture is cooled to room temperature, and 28.4 g aqueous sodium hydroxide solution (8 wt %) is added. Then, 0.88 g Tego® Antifoam 2263XP (commercially available from Evonik Degussa Specialty Chemicals (Shanghai) Co., Ltd.) is added. Finally, 3.9 g fungicide ACTICIDE MV (commercially available from Thor Specialties China Co., Ltd.) is added. The obtained dispersion has a pH of 7.5, a solid content of 56.7% based on the total weight of the dispersion, T_{g} of −15° C., a viscosity of 353 mPa·s, a number-average particle diameter of 196 nm, M_{w} of 168,430 and M_{w}/Mₙ of 3.6.

TABLE 5

| | | |
|---|---|---|
| Initial Charge: | Demineralized water | 344.5 g |
| | Vorproduct T6772 | 11.8 g |
| Feed 1: | Demineralized water | 344.5 g |
| | Disponil ® FES 77 | 78.0 g |
| | Lutensol ® AT 18 | 65.0 g |
| | Styrene | 335.4 g |
| | n-Butyl acrylate | 754.0 g |
| | 2-Ethylhexyl acrylate | 130.0 g |
| | 2-Hydroxyethyl methacrylate | 78.0 g |
| | Acrylic acid | 2.6 g |
| Feed 2: | Aqueous sodium persulfate solution (7 wt %) | 74.3 g |

### Comparative Example 1

A comparative dispersion is prepared through a process as described below with starting materials shown in Table 6.

The initial charge is added into a reaction vessel with stirring at 120 rpm, and heated to 92° C. When the temperature was reached, 3.7 g of Feed 2 is metered in over 5 minutes. Subsequent-ly, Feed 1 and the remainder of Feed 2 are metered in simultaneously over 4 hours under stirring. The polymerization mixture is then left to post-polymerization at 92° C. for 0.5 hour. The mixture is cooled to 87° C., and 30.4 g aqueous t-butyl hydroperoxide solution (10 wt %) and 41 g of sodium bisulfite solution in acetone (13 wt %) are metered in over 2 hours. The resulting mixture is cooled to room temperature. Into the mixture, 16.3 g aqueous sodium hydroxide solution (8 wt %) is added. Then, 78 g Emulan TO® 40 solution (20 wt %, commercially available from BASF (China) Co., Ltd.) is added, followed by 0.88 g Tego® Antifoam 2263XP (commercially available from Evonik Degussa Specialty Chemicals (Shanghai) Co., Ltd.), and then 3.9 g fungicide ACTICIDE MV (commercially available from Thor Specialties China Co., Ltd.) is added. The obtained dispersion has a pH of 7.9, a solid content of 56.7% based on the total weight of the dispersion, T_{g} of −9° C., a viscosity of 1025 mPa·s, a number-average particle diameter of 198 nm, M_{w} of 176,772 and M_{w}/Mₙ of 3.3.

TABLE 6

| | | |
|---|---|---|
| Initial Charge: | Demineralized water | 351.0 g |
| | Vorproduct T6772 | 9.9 g |
| Feed 1: | Demineralized water | 247.0 g |
| | Disponil ® FES 77 | 40.7 g |
| | Sodium bicarbonate (6 wt %, aqueous solution) | 43.3 |
| | Styrene | 364 g |
| | n-Butyl acrylate | 903.5 g |
| | Acrylamide (30 wt %, aqueous solution) | 108.3 g |
| Feed 2: | Aqueous sodium persulfate solution (7 wt %) | 74.3 g |

### Comparative Example 2

A comparative dispersion is prepared through a process as described below with starting materials shown in Table 7.

The initial charge is added into a reaction vessel with stirring at 120 rpm, and heated to 95° C. When the temperature was reached, 5.4 g of Feed 2 is metered in over 5 minutes. Subsequent-ly, Feed 1 and the remainder of Feed 2 are metered in simultaneously over 3.5 hours under stirring. The polymerization mixture is then left to post-polymerization at 95° C. for 1 hour. The mixture is cooled to 90° C., and 39.0 g aqueous t-butyl hydroperoxide solution (10 wt %) and 43.9 g of sodium bisulfite solution in acetone (13 wt %) are metered in over 2 hours. The resulting mixture is cooled to room temperature. Into the mixture, 37.5 g aqueous sodium hydroxide solution (8 wt %) is added. Then, 1.02 g Tego® Antifoam 2263XP (commercially available from Evonik Degussa Specialty Chemicals (Shanghai) Co., Ltd.), and then 6.0 g fungicide ACTICIDE MV (commercially available from Thor Specialties China Co., Ltd.) is added. The obtained dispersion has a pH of 7.9, a solid content of 56.7% based on the total weight of the dispersion, T_{g} of −4.2° C., a viscosity of 648 mPa·s, and a number-average particle diameter of 194 nm, M_{w} of 135,894 and M_{w}/Mₙ of 3.5.

TABLE 7

| | | |
|---|---|---|
| Initial Charge: | Demineralized water | 397.5 g |
| | Vorproduct T6772 | 11.4 g |
| Feed 1: | Demineralized water | 375.0 g |
| | Disponil ® FES 77 | 46.9 g |
| | Lutensol ® AT 18 | 112.5 g |
| | Styrene | 507.2 g |
| | n-Butyl acrylate | 891.0 g |
| | 2-Ethylhexyl acrylate | 75.0 g |
| | 2-Hydroxyethyl methacrylate | 24.0 g |
| | Methacrylic acid | 2.9 g |
| Feed 2: | Aqueous sodium persulfate solution (7 wt %) | 107.1 g |

Vorproduct T6772: an aqueous polystyrene seed dispersion, solid content of 33 wt %, from Shanghai Gaoqiao BASF Dispersions Co., Ltd., China;
Lutensol® AT 18: a nonionic emulsifier, C₁₆C₁₈-fatty alcohol ethoxylates, 18 EO, solid content of 20 wt %, from BASF SE;
Disponil® FES 77: an anionic emulsifier, sodium salt of C₁₂C₁₄-fatty alcohol ether sulfate, 30 EO, solid content of 32 wt %, from BASF (China) Co., Ltd;
Disponil® FES 27: an anionic emulsifier, sodium salt of C₁₂C₁₄-fatty alcohol ether sulfate, 2 EO, solid content of 27 wt %, from BASF (China) Co., Ltd.

The monomeric composition, in % by weight, of the copolymers contained in respective dispersions is summarized in Table 8. There, nBA is n-butyl acrylate, 2-EHA is 2-ethylhexyl acrylate, St is styrene, MMA is methyl methacrylate, HEA is 2-hydroxyethyl acrylate, HPA is 2-hydroxypropyl acrylate, HEMA is 2-hydroxyethyl methacrylate, AA is acrylic acid, MAA is methacrylic acid, and AM is acrylamide.

TABLE 8

| | Monomeric composition of the copolymers | | | | | | |
|---|---|---|---|---|---|---|---|
| | Example | Example | Example | Example | Example | Comp. | Comp. |
| | 1 | 2 | 3 | 4 | 5 | Ex. 1 | Ex. 2 |
| (a) | St | St | St | St | St | St | St |
| | 26% | 29% | 31.9% | 33% | 25.8% | 28% | 33.8% |
| | MMA | | | | | | |
| | 3% | | | | | | |
| (b) | nBA | nBA | nBA | nBA | nBA | nBA | nBA |
| | 60.1% | 65.8% | 60.6% | 57.4% | 58% | 69.5% | 59.4% |
| | 2-EHA | | 2-EHA | 2-EHA | 2-EHA | | 2-EHA |
| | 5% | | 5% | 5% | 10% | | 5% |
| (c) | HEMA | HEA | HEMA | HPA | HEMA | 0 | HEMA |
| | 5.4% | 4.7% | 2% | 4% | 6% | | 1.6% |
| (d) | AA | AA | AA | AA | AA | 0 | MAA |
| | 0.5% | 0.1% | 0.1% | 0.6% | 0.2% | | 0.2% |
| | | MAA | MAA | | | | |
| | | 0.4% | 0.4% | | | | |
| (e) | 0 | 0 | 0 | 0 | 0 | AM | 0 |
| | | | | | | 2.5% | |

### Application Examples

### General Procedure:

The liquid components and the powder components are mixed in accordance with the formulation as shown in Table 9 below, stirred for 3 to 5 minutes. The resulted formulation was applied onto a polytetrafluoroethylene panel by a blade coater to obtain a cementitious waterproofing film with a thickness of 2 mm. The film is hardened for 4 days under standard cli-mate condition (23° C., 50% relative humidity), and followed by 2 days in 40° C. oven. Tests for properties of the film were carried out after cooling the film in a desiccator to the room temperature.

TABLE 9
Cementitious Waterproofing Formulation

| | Amounts, g | | | | | | |
|---|---|---|---|---|---|---|---|
| | Example | Example | Example | Example | Example | Comp. | Comp. |
| Components | 1 | 2 | 3 | 4 | 5 | Ex. 1 | Ex. 2 |
| Liquid | | | | | | | |
| Copolymer dispersion | 324 | 331 | 343 | 323 | 323 | 324 | 323 |
| Antifoaming agent | 5 | 5 | 5 | 5 | 5 | 5 | 5 |
| (Lumiten EL, 100%, | | | | | | | |
| from BASF (China) | | | | | | | |
| Co., Ltd.) | | | | | | | |
| Deionized water | 28 | 21 | 9 | 29 | 29 | 28 | 29 |
| Powder | | | | | | | |
| Portland Cement | 427 | 427 | 427 | 427 | 427 | 427 | 427 |
| P. O 42.5 (from | | | | | | | |
| Anhui Conch Cement | | | | | | | |
| Co., Ltd., China) | | | | | | | |
| Quartz sand | 108 | 108 | 108 | 108 | 108 | 108 | 108 |
| (70-100 mesh) | | | | | | | |
| Quartz sand | 108 | 108 | 108 | 108 | 108 | 108 | 108 |
| (100-200 mesh) | | | | | | | |
| In Total | 1000 | 1000 | 1000 | 1000 | 1000 | 1000 | 1000 |

For the seven cementitious waterproofing films prepared from the copolymer dispersions from Example 1, Example 2, Example 3, Example 4, Example 5, Comparative Example 1 and Comparative Example 2 respectively, tensile strength, adhesive strength and elongation at break are measured according to the test method GB/T 1677-2008 as described hereinabove. Particularly, cement plate is used as the substrate in the adhesive strength measurement.

In addition, ammonia release is measured for the seven dispersions from Example 1, Example 2, Example 3, Example 4, Example 5, Comparative Example 1 and Comparative Example 2 respectively.

### Test Results

The mechanical properties and released ammonia amounts measured for the Examples and Comparative Examples are summarized in Table 10 below.

TABLE 10

| | Example | Example | Example | Example | Example | Comp. | Comp. |
|---|---|---|---|---|---|---|---|
| Samples | 1 | 2 | 3 | 4 | 5 | Ex. 1 | Ex. 2 |
| Tensile Strength | 2.3 | 2.1 | 1.8 | 2 | 2.1 | 2.1 | 1.1 |
| (Mpa) | | | | | | | |
| Elongation at break | 140 | 152 | 122 | 103 | 144 | 153 | 222 |
| (%) | | | | | | | |
| Adhesive strength | 1 | 1.1 | 0.9 | 1 | 1.1 | 1.1 | 0.6 |
| (Mpa) | | | | | | | |
| Ammonia (mg/kg) | 34 | 34 | 34 | 33 | 34 | 1230 | 37 |

It can be seen from the results shown in Table 10 that compared with the Comparative Example 1, the dispersions of Examples 1, 2, 3, 4 and 5 according to the present invention result in significantly reduced ammonia release. It is obvious that the ammonia release amount in case of the dispersions according to the present invention can meet JC 1066-2008 standard, while the Comparative Example 1 fails.

Furthermore, the dispersions of Examples 1, 2, 3, 4 and 5 according to the present invention show comparable performance to the Comparative Example 1 which contains acrylamide in terms of the tensile strength, elongation at break and adhesive strength of the cementitious waterproofing films prepared from respective dispersions.

The dispersions of Examples 1 to 5 according to the present invention show improved performance in terms of the tensile strength, elongation at break and adhesive strength of the cementitious waterproofing films prepared from respective dispersions, compared with the Comparative Example 2, which can also meet JC 1066-2008 standard, but has a tensile strength failing to meet general requirements.

1. A dispersion of a (meth)acrylate copolymer containing a hydroxyalkyl (meth)acrylate comonomer unit, which is obtained from polymerization of monomers comprising, based on the total monomer weight,
(a) from 25 to 45% by weight of at least one monovinyl aromatic monomer, methyl methacrylate, or a combination thereof;
(b) from 50 to 70% by weight of at least one C₄₋₈ alkyl (meth)acrylate;
(c) from 2 to 7% by weight of at least one hydroxyalkyl (meth)acrylate;
(d) from 0 to 1% by weight of at least one α,β-monoethylenically unsaturated C₃₋₆ monocarboxylic or dicarboxylic acid; and
(e) from 0 to 0.65% by weight of (meth)acrylamide, N-hydroxyalkyl (meth)acrylamide, 2-acrylamido-2-methylpropane sulfonic acid, or a combination thereof.

2. The dispersion according to claim 1, which is obtained from polymerization of monomers comprising, based on the total weight of all monomers,
(a) from 25 to 40% by weight of at least one monovinyl aromatic monomer and/or methyl methacrylate;
(b) from 55 to 70% by weight of at least one C₄₋₈ alkyl (meth)acrylate;
(c) from 2 to 6% by weight of at least one hydroxyalkyl (meth)acrylate; and
(d) from 0.05 to 1% by weight of at least one α,β-monoethylenically unsaturated C₃₋₆ monocarboxylic or dicarboxylic acid.

3. The dispersion according to claim 1, wherein the at least one hydroxyalkyl (meth)acrylate is selected from the group consisting of hydroxy-C₂₋₁₀ alkyl acrylates, hydroxy-C₂₋₁₀ alkyl methacrylates, and a combination thereof.

4. The dispersion according to claim 3, wherein the at least one hydroxyalkyl (meth)acrylate is selected from the group consisting of 2-hydroxyethyl acrylate, 2-hydroxypropyl acrylate, 3-hydroxypropyl acrylate, 2-hydroxybutyl acrylate, 4-hydroxybutyl acrylate, 2-hydroxyethyl methacrylate, 2-hydroxypropyl methacrylate, 3-hydroxypropyl methacrylate, 2-hydroxybutyl methacrylate, 4-hydroxybutyl methacrylate and any combinations thereof, preferably 2-hydroxyethyl acrylate, 2-hydroxyethyl methacrylate, 2-hydroxypropyl acrylate, 2-hydroxypropyl methacrylate and a combination thereof.

5. The dispersion according to claim 1, wherein the at least one monovinyl aromatic monomer is selected from the group consisting of styrene, α-methyl styrene, o- or p-vinyl toluene, p-bromo styrene, p-tert-butyl styrene, o-, m- or p-chlorostyrene, and a combination thereof.

6. The dispersion according to claim 1, which is obtained from a radically initiated polymerization.

7. The dispersion according to claim 1, wherein the copolymer has a glass transition temperature in a range of from −2° C. to −16° C.

8. A powder of a (meth)acrylate copolymer containing a hydroxyalkyl (meth)acrylate comonomer unit, obtained by drying the dispersion according to claim 1.

9. A flexible cementitious waterproofing material, comprising:
the dispersion according to claim 1; and
a cement component.

10. A method for making a flexible cementitious waterproofing material, comprising:
mixing a modifier comprising the dispersion according to claim 1 with a cement component.

11. The flexible cementitious waterproofing material according to claim 9, wherein the cement component is selected from the group consisting of a Portland cement, a pozzolanic cement, a hydraulic lime, fly ash, a natural cement, and a combination thereof.

12. The flexible cementitious waterproofing material according to claim 11, wherein the dispersion is included in an amount of 10 to 100% by weight, in terms of the solid content, relative to a weight of the cement component in the flexible cementitious waterproofing material.

13. The flexible cementitious waterproofing material according to claim 9, further comprising:
an additive selected from the group consisting of an inorganic filler, a rheology modifier, a superplasticizer, a defoamer, a coalescence agent, a plasticizer, and a combination thereof.

14. A kit of parts for a flexible cementitious waterproofing material, comprising:
a first part (A) comprising the dispersion according to claim 1; and
a second part (B) comprising a cement component selected from the group consisting of a Portland cement, a pozzolanic cement, a hydraulic lime, fly ash, a natural cement, and a combination thereof, an inorganic filler component, and an optional additive selected from the group consisting of a rheology modifier, a superplasticizer, a defoamer, a coalescence agent, a plasticizer, and a combination thereof.

15. A flexible cementitious waterproofing material, comprising:
the powder according to claim 8;
a cement component selected from the group consisting of a Portland cement, a pozzolanic cement, a hydraulic lime, fly ash, and a natural cement;
an inorganic filler component; and
an optional additive selected from the group consisting of a rheology modifier, a superplasticizer, a defoamer, a coalescence agent, a plasticizer, and a combination thereof.

16. The method according to claim 10, wherein the cement component is selected from the group consisting of a Portland cement, a pozzolanic cement, a hydraulic lime, fly ash, a natural cement, and a combination thereof.

17. The dispersion according to claim 1, which is obtained from polymerization of monomers consisting of, based on the total monomer weight,
(a) from 25 to 45% by weight of the at least one monovinyl aromatic monomer, methyl methacrylate, or a combination thereof;
(b) from 50 to 70% by weight of the at least one C₄₋₈ alkyl (meth)acrylate;
(c) from 2 to 7% by weight of the at least one hydroxyalkyl (meth)acrylate;
(d) from 0 to 1% by weight of the at least one α,β-monoethylenically unsaturated C₃₋₆ monocarboxylic or dicarboxylic acid; and
(e) from 0 to 0.65% by weight of the (meth)acrylamide, N-hydroxyalkyl (meth)acrylamide, 2-acrylamido-2-methylpropane sulfonic acid, or a combination thereof.
